(19) United States
(12) Patent Application Publication
(10) Pub. No.: US 2025/0245543 A1
(43) Pub. Date: Jul. 31, 2025

(54) Self-Consistent Recovery of Configurations from Noisy Concentrated Wave Functions Applied to Quantum Selected Configuration Interaction

(71) Applicant: International Business Machines Corporation, Armonk, NY (US)

(72) Inventors: Javier Robledo MORENO, New York, NY (US); Mario MOTTA, San Jose, CA (US); Antonio MEZZACAPO, Brooklyn, NY (US); Kunal SHARMA, White Plains, NY (US); Minh TRAN, Cambridge, MA (US); William KIRBY, Cambridge, MA (US); Kevin Jeffery SUNG, Demarest, NJ (US)

(21) Appl. No.: 18/422,387

(22) Filed: Jan. 25, 2024

(51) Int. Cl. G06F 9/445; G06N 10/70

(52) U.S. Cl. CPC G06N 10/60

(57) ABSTRACT

The various embodiments pertain to extracting one or more noiseless configurations from a collection of noisy configurations generated by a quantum processor. A configuration can be represented as a series of bits, 1's and 0's, whereby 1 indicates a spin orbital is occupied and 0 indicates spin orbital is empty. Noise in the quantum system can cause a respective bit to be flipped from a 0 to a 1, and vice-versa. During removal of the noise effect(s), bits can be flipped from their current value to an alternate value (e.g., 0→1, 1→0). After bit flipping, a Hamiltonian diagonalization process can be applied to the noiseless configuration to generate an eigenstate from which a ground state of the system represented by the noisy configuration can be determined. The system can be an atom or molecule, with the bits relating to a spin orbital of an electron.

### BACKGROUND

The subject disclosure relates to automatically determining one or more ground state properties of a molecule as predicted by a quantum computer in the presence of quantum noise.

### SUMMARY

The following presents a summary to provide a basic understanding of one or more embodiments described herein. This summary is not intended to identify key or critical elements, or delineate any scope of the different embodiments and/or any scope of the claims. The sole purpose of the Summary is to present some concepts in a simplified form as a prelude to the more detailed description presented herein.

In one or more embodiments described herein, systems, devices, computer-implemented methods, methods, apparatus and/or computer program products are presented that facilitate automatically reducing an effect of quantum noise on one or more quantum configurations to enable determination of a ground state of a system (e.g., an atom, molecule, quantum many-body system, and suchlike).

According to one or more embodiments, a device is provided to determine an approximation to the ground state of a system utilizing one or more configurations generated in a noisy quantum processor. The system can comprise a memory operatively coupled to the system, wherein the memory stores computer executable components and a processor that executes the computer executable components stored in the memory. The computer executable components can comprise a self-consistent configuration recovery (SCR) component configured to: identify a first noisy quantum configuration in a series of quantum configurations associated with a ground state of a system, further process the first noisy quantum configuration to remove an effect of noise on the first noisy quantum configuration, wherein processing of the first noisy quantum configuration generates a first noiseless quantum configuration, and further determine a first ground state of the system, wherein the determination includes generating a first Hamiltonian generated from the series of quantum configurations including the first noiseless quantum configuration. In an embodiment, first noisy quantum configuration is generated in a quantum computer configured to represent the system. In an embodiment, the system can represent one of an atom or a molecule for which one or more location probabilities of an atomic particle is being determined. In an embodiment, the atomic particle can be a boson or a fermion.

In another embodiment, the first noisy quantum configuration can include a first bit string comprising a series of spin orbitals representing respective probabilities of location and spin of an electron in the system, wherein a value 0 in the bit string represents an empty spin orbital and a value of 1 in the bit string represents an occupied spin orbital.

In a further embodiment, the SCR component can be further configured to diagonalize the first Hamiltonian generated from the noisy quantum configuration to obtain the first ground state. In another embodiment, the SCR component can be further configured to generate the first noiseless quantum configuration by flipping a value of one of the spin orbitals to an opposite value, wherein in the event that a spin orbital value in the first noisy quantum configuration is a zero, flipping the spin orbital value to a value of one.

In a further embodiment, the first noisy quantum configuration can be included in a set of noisy quantum configurations. The set of noisy quantum configurations can further comprise an n^{th} noisy quantum configuration, whereby the SCR component can be further configured to remove an effect of noise on the n^{th} noisy configuration to generate an n^{th} noiseless quantum configuration, and further determine the first ground state of the system based on the first Hamiltonian generated from the series of quantum configurations including the first noiseless quantum configuration and the n^{th} noiseless quantum configuration.

In another embodiment, the SCR component can be further configured to identify the first noisy quantum configuration based on the occupied spin orbitals in the first bit string, wherein the number of occupied spin orbitals equals a number of electrons identified for the system.

In another embodiment, the SCR component can be further configured to (a) identify a second noisy configuration in the series of quantum configurations, (b) process the second noisy quantum configuration to remove an effect of noise on the second noisy quantum configuration, wherein processing of the second noisy quantum configuration generates a second noiseless quantum configuration, (c) diagonalize a second Hamiltonian to generate a second ground state based on the series of quantum configurations including the second noiseless quantum configuration, (d) compare the first ground state with the second ground state, and (e) in response to a determination that a difference between the first ground state and the second ground state satisfies a convergence value, present the second ground state as the ground state of the system.

In other embodiments, elements described in connection with the disclosed systems can be embodied in different forms such as computer-implemented methods, computer program products, or other forms. In an embodiment, a computer-implemented method can be performed by a device operatively coupled to a processor. In an embodiment, the computer-implemented method can comprise automatically receiving, by the device, a set of configurations, wherein the set of configurations are generated in a quantum processor experiencing quantum noise, further diagonalizing, by the device, a first Hamiltonian generated from the set of configurations, and further generating, by the device, a first ground state from the first Hamiltonian. The computer-implemented method can further comprise identifying, by the device, a first number of electrons for a system represented by the set of configurations, further determining, by the device, a first configuration in the set of configurations, wherein the first configuration has a second number of electrons, wherein the second number of electrons is not equal to the first number of electrons, and further modifying, by the device, the first configuration by flipping a value of a first spin-orbital in the spin-orbitals in the first configuration to remove an effect of the quantum noise on the first configuration.

In a further embodiment, the computer-implemented method can further comprise updating, by the device, the set of configurations with the modified first configuration, further diagonalizing, by the device, a second Hamiltonian generated from the set of configurations, and further generating, by the device, a second ground state from the second Hamiltonian.

In another embodiment, the computer-implemented method can further comprise receiving, by the device, a stop criterion, further comparing, by the device, the second ground state with the stop criteria, and further, in response to a determination, by the device, that the second ground state complies with the stop criteria, outputting the second ground state as being the ground state of the system represented by the set of configurations.

In another embodiment, the computer-implemented method can further comprise (a) identifying, by the device, a first noisy configuration in the set of configurations, wherein a probable position of an atomic particle associated with the first noisy configuration is represented by a bit string of spin orbitals, (b) modifying, by the device, a first spin orbital in the bit string of spin orbitals from a first value to a second value to convert the first noisy configuration to a first noiseless configuration, (c) updating, by the device, the set of configurations to include the first noiseless configuration, (c) diagonalizing, by the device, a second Hamiltonian generated from the updated set of configurations, (d) generating, by the device, a second ground state from the second Hamiltonian, (e) comparing, by the device, the first ground state with the second ground state, and (f) in response to determining, by the device, the first ground state and the second ground state are converging, outputting the second ground state as a ground state of the system.

Another embodiment can further comprise a computer program product stored on a non-transitory computer-readable medium and comprising machine-executable instructions, wherein, in response to being executed, the machine-executable instructions cause a machine to perform operations, wherein the operations can comprise receiving a set of configurations, wherein the set of configurations are generated in a quantum processor experiencing quantum noise, diagonalizing a first Hamiltonian generated from the set of configurations, and further generating a first ground state from the first Hamiltonian.

In a further embodiment, the operations can further comprise identifying a first number of electrons for a system represented by the set of configurations, further determining a first configuration in the set of configurations, wherein the first configuration has a second number of electrons, wherein the second number of electrons is not equal to the first number of electrons, and further modifying the first configuration by flipping a value of a first spin-orbital in the spin-orbitals in the first configuration to remove an effect of the quantum noise on the first configuration. The operations can further comprise updating the set of configurations with the modified first configuration, diagonalizing a second Hamiltonian generated from the updated set of configurations, and further generating a second ground state from the second Hamiltonian.

### DESCRIPTION OF THE DRAWINGS

One or more embodiments are described below in the Detailed Description section with reference to the following drawings:

FIG. 1 presents a system to implement a SCR process to determine a ground state of an electron/atom/molecule, in accordance with an embodiment.

FIG. 2 illustrates a computer-implemented process for determining a ground state of an electron/atom/molecule, in accordance with an embodiment.

FIG. 3 illustrates a computer-implemented process for post-processing a sample configuration in a set of noisy configurations, in accordance with an embodiment.

FIG. 4 presents a schematic of the respective components of a configuration x, and the effect of quantum noise thereon, in accordance with an embodiment.

FIG. 5A presents a chart of recovering electronic configurations for a N₂ molecule with a bond length of 1.0 Angstrom, in accordance with an embodiment.

FIG. 5B presents a chart of recovering electronic configurations for a N₂ molecule with a bond length of 3.0 Angstroms, in accordance with an embodiment.

FIG. 5C presents a chart depicting the values of the entries of the vector of reference occupancies n over a series of iterations for a 1 Angstrom bond length N₂ molecule, in accordance with an embodiment.

FIG. 5D presents a chart depicting the values of the entries of the vector of reference occupancies n over a series of iterations for a 3 Angstrom bond length N₂ molecule, in accordance with an embodiment.

FIG. 6 presents a chart illustrating respective distances of from boundary conditions of occupied (1) and empty (0) spin-orbitals, in accordance with an embodiment.

FIG. 7 presents a chart comprising a log-linear plot of the probability of recovery of a configuration as a function of the number of qubits, in accordance with an embodiment.

FIG. 8 illustrates a computer-implemented process for determining a ground state in a noisy quantum system, according to one or more embodiments.

FIG. 9 depicts an example schematic block diagram of a computing environment with which the disclosed subject matter can interact/be implemented at least in part, in accordance with various aspects and implementations of the subject disclosure.

FIG. 10 presents a quantum computing system one which one or more embodiments presented herein can be implemented, in accordance with various aspects and implementations of the subject disclosure.

FIG. 11 presents an overview of a conventional hybrid quantum-classical QSCI process.

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Ranges A-n and 1-i are utilized herein to indicate a respective plurality of devices, components, statements, attributes, etc., where n and i are any positive integer. The terms characterize, categorize, identify, determine, are used interchangeably herein. It is to be appreciated that any process/operation performed in the respective embodiments presented herein can be performed automatically (e.g., by any of quantum computer 150, classical computer 150, processor 182, computer 901, quantum computer 1020, and suchlike, as further described).

Throughout the following, the tilde symbol “˜” is used to identify a “noisy” counterpart to a “noiseless” parameter, probability, configuration, set of configurations, etc.

### Terms

QSCI: quantum selected configuration interaction—a hybrid quantum-classical algorithm/process.
Eigenstate of an operator (Eigenfunction, Eigenvector): a specific, well-defined, mathematical function/entity representing a state of a physical system, which enables calculation of probability of a quantum system being in a particular state, as well as any physical quantity. With regard to the various embodiments presented herein, an eigenstate is defined as the weighted linear combination of basis states of configurations. An eigenstate remains unchanged, up to a scaling factor (eigenvalue), under the action of the corresponding operator. An eigenstate represents a specific property. Superposition is a combination of multiple eigenstates having different probabilities. Eigenstates cannot be observed directly, but can be derived by measuring a system property, such as energy or momentum. The eigenstate of the Hamiltonian operator whose eigenvalue has the lowest value is known as the Ground State.
Quantum State |Q [symbol] : any of various states of a physical system (such as an electron). A quantum state could be a single configuration or a single eigenstate, or a superposition of configurations, or a superposition of eigenstates.
Computational Basis: two basis states composed by (any of) two distinct quantum states that the qubit can be in physically, where Q is a first computational basis and |1)—second computational basis.
Number of qubits, M=wherein M can be twice the number of spatial-orbitals describing the system.
System/quantum system: subject matter of interest, such as an electron(s) in an atom(s), molecule(s), and suchlike, and the probable location of an electron in the system to facilitate knowledge regarding one or more properties of the system, e.g., one or more chemical reactions between the atom/molecule (that includes the electron(s) of interest) and other atoms/molecules.
x=bit string representing occupancy of spin orbitals (configuration), e.g., for an electron. Also referred to as configuration.
n: Vector of average spin-orbital occupancies. The vector has as many entries as spin-orbitals there are in the system. Each entry can take any real value between 0 and 1. The sum of the elements of n determines the number of electrons/particles N.
P_{Q}= [symbol] x|Q [symbol] probability of a noiseless configuration.
χ=set of configurations x, representing a subspace in the space of many body configurations.
Hamiltonian, H: operator corresponding to the energy of a system.
Hₓ=Hamiltonian projected into the subspace defined by χ, where χ represents a set of configurations x.
ψ=wave-function amplitudes.
N=Number of electrons/particles in the system. It is given by the Hamming Weight of any noiseless bit string representing the occupancy of spin orbitals. Same as number of occupied spin-orbitals in a noiseless bit string of spin orbitals. Can also be determined as the sum of the components of n.
Ground State: also referred to as the ground state wave function (e.g., a wave function having the lowest energy), from which any pertinent information regarding the system can be obtained/determined, such as a description of the system (e.g., atom/molecule), probability of finding an electron at a particular location, energy of the system, an electrical charge, and suchlike.
Ground State Energy: stationary lowest energy state of a quantum-mechanical system (aka zero-point energy of the system). Also, smallest eigenvalue of the Hamiltonian operator.
Excited state: any eigenstate of the Hamiltonian of the system with an energy greater than the ground state.
Spatial orbital: quantum state representing probabilities of finding an electron at points in space in an atom, molecule.
Many-body configuration: pertains to the complexity inherent in a quantum system comprising numerous particles/qubits, interactions, and suchlike, where a many-body configuration represents, for example occupancies of spin orbitals.

### Introduction to QSCI Process

A Quantum Selected Configuration Interaction (QSCI) process is a hybrid quantum-classical algorithm applied to a series of quantum state samples to determine eigenstates of interacting-electron Hamiltonians. QSCI has numerous applications, including quantum chemistry, with application of quantum mechanics to chemical systems enabling quantum-mechanical calculation of electronic contributions to physical and chemical properties of molecules, materials, and solutions at the atomic level. Herein an approximate eigenstate is defined as linear combinations of many-body configurations sampled from a quantum device.

QSCI assumes that a target wave function is concentrated in a particular computational basis, whereby the accuracy of QSCI is deleteriously affected as the number of wrong samples in a total number of samples drawn from the quantum device increases, e.g., as a function of increased noise in the quantum device. For systems comprising a small number of qubits and/or when noise in the quantum device is minimal, QSCI can provide relatively accurate estimates of the target estimates. However, for devices comprising moderate to large numbers of qubits and/or with moderate to large amounts of device noise, QSCI requires a prohibitively-large number of measurements/samples to be analyzed and extensive classical resources to produce accurate results. For example, the effects of noise may be lessened over a larger number of measurements as knowledge derived from a correct/noiseless value offsets the obfuscation of an incorrect/noisy value.

As mentioned, as the complexity of a system increases (e.g., number of qubits, degree of device noise, and suchlike) the number of measurements/samples to be conducted and further, the magnitude of classical resources required to produce accurate results, can become prohibitively high for application of a QSCI process. The various embodiments presented herein enable a higher number of qubits and/or device noise to be accommodated for implementation of a QSCI process to produce accurate estimates of the target eigenstates, compared with the restricted complexity of a conventional QSCI approach.

Quantum noise (aka device noise) can arise from various sources within a quantum system, and includes thermal fluctuations, electromagnetic interference, imperfections in quantum gates, interactions by qubits of interest with the system environment, and suchlike. Different types of quantum noise exist and can affect qubits in respective ways. For example, phase noise alters the relative phase between the basis states of a qubit, while amplitude noise affects the probabilities of measuring different states.

Quantum noise can lead to effects such as qubit decoherence and an associated loss of quantum information (e.g., superposition, entanglement, and suchlike). Accordingly, while numerous approaches to mitigate noise are being utilized/pursued (e.g., quantum error correction codes, qubit isolation, precise control technology, and suchlike), unless noise can be completely eradicated, techniques and technologies are required to accommodate noise to enable use and development of existing and future systems, particularly with regard to scale (e.g., number of qubits available in a quantum system).

A quantum state |Q [symbol] of a quantum system can have a complexity such that only one or more probabilities P can be provided, e.g., regarding electron position, and further, with the introduction of noise, confidence in a determined probability accordingly reduces, which can have an associated reduced impetus to develop/apply quantum computing systems to solving problems beyond those that can be readily solved with classical-based computing systems.

### Overview of Conventional QSCI Process

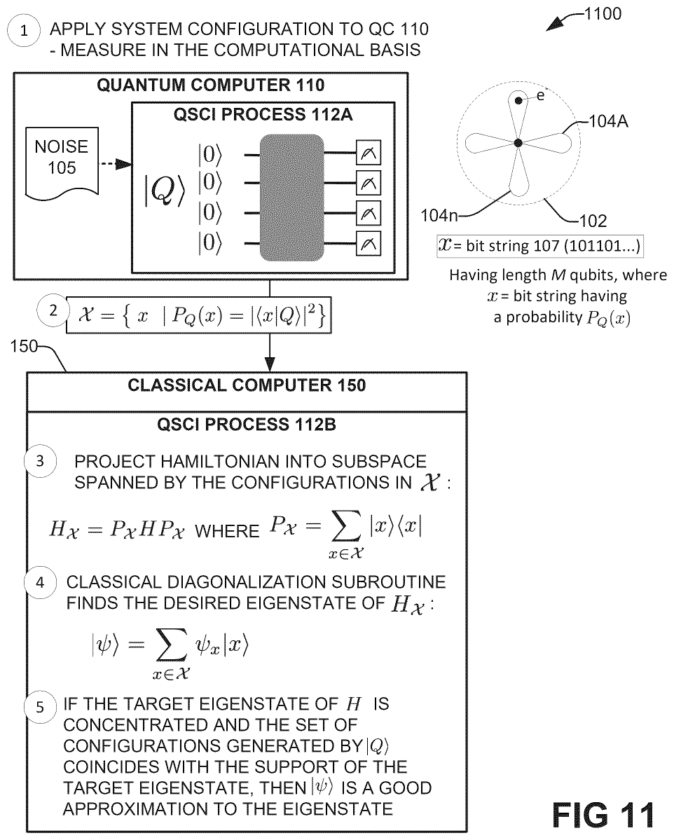

Turning to FIG. 11, schematic 1100 presents an overview of a conventional hybrid quantum-classical QSCI process. As shown, a QSCI process 112 can comprise a hybrid quantum-classical algorithm/process, whereby QSCI process 112A (first portion of QSCI process 112) can be implemented on a quantum computer 110 to generate information regarding a system (e.g., predictions and probabilities of location, orbital occupancy 104A-n, spin, etc., of an electron(s), etc., in a molecule 102). The derived information can be subsequently applied to a classical computer 150 to facilitate Hamiltonian diagonalization and eigenstate determination by QSCI process 112B (second portion of QSCI process 112).

As shown, at (1), a quantum state |Q [symbol] is prepared in a quantum processor 110 (aka, a quantum computer, a quantum device, a device). The number of qubits M is twice the number of spin/orbitals/spatial-orbitals 104A-n describing the system. The computational basis of each qubit represents the occupancy of a spin-orbital of the system, whereby the computational basis is given by |0)↔empty spin orbital, and |1)↔occupied spin orbital.

Quantum state |Q) can be generated at the quantum processor 110 by any suitable technology, such as utilizing a variational quantum eigensolver (VQE) to find the ground state/ground-state energy, variational quantum deflation (VQD) (a variant of VQE for excited state energies), and suchlike.

At (2), a projective measurement on |Q), in the computational basis (e.g., |0) or |1) ), produces a bit string x (configurations 107A-n) representing the occupancy of the spin orbitals 104A-n, wherein the length/number/sequence of 0's and 1's in bit string x totals the number of qubits M. Each configuration 107A-n/x is sampled with probability

PQ(x)=| [symbol] x|Q)|².

A set of configurations χ is collected from the projective measurements provides a subspace in which the Hamiltonian His projected, where

χ={x|PQ(x)=| [symbol] x|Q)|2}.

In an aspect, the information regarding a configuration can be presented as a bit string, whereby the bit string/configuration is interchangeably referenced herein as configuration/bit string 107A-n and/or configuration/bit string x (e.g., when bit string x is being applied to an equation). Further, set of configurations 108A-n/χ comprises a series of configurations 107A-n/x.

It is required that the size of χ is a polynomial of the qubit number M, e.g.,

|χ|˜ [symbol] (Poly(M)).

As shown in FIG. 11, steps (1) and (2) can be performed by quantum computer 110. As further shown, the subsequent steps (3)-(5) can be performed by classical computer 150.

At (3), χ provides a subspace in the space of many-body configurations.

Hamiltonian H can be efficiently projected into such subspace by the classical computer 150, where:

Hₓ=PₓHPₓ

and wherein

$${P}_{χ} = {\sum }_{x ∈ χ} \vert x 〉 〈 x \vert .$$

At (4), Hₓ can be diagonalized by a diagonalization subroutine, e.g., Lanczos, Davidson methods/process 112B on classical computer 150, yielding an approximation to an eigenstate of H:

$$\vert ψ 〉 = {\sum }_{x ∈ χ} {ψ}_{x} \vert x 〉 .$$

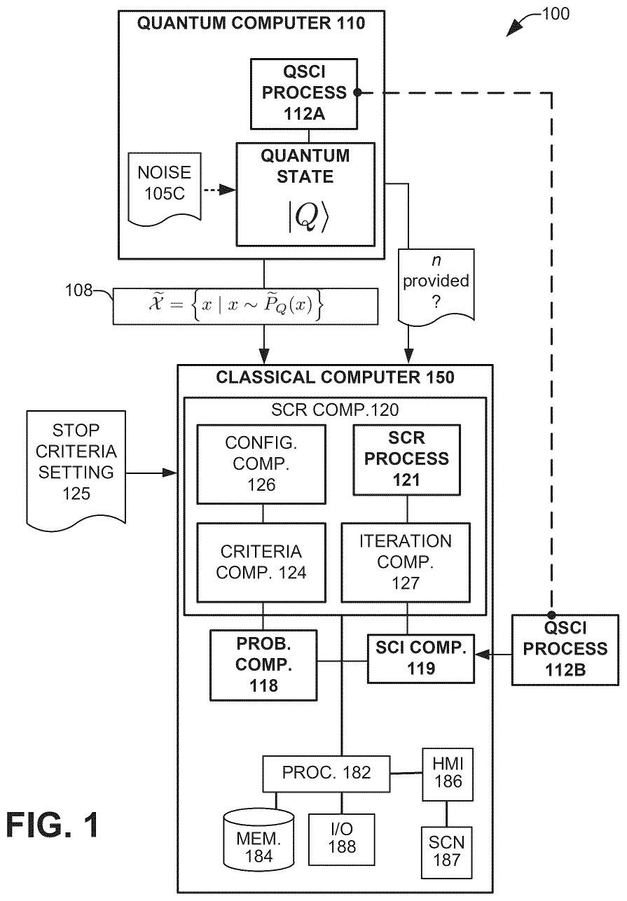

The wave-function amplitudes ψₓ can be determined by the diagonalization of Hₓ, wherein the wave function components/amplitudes ψₓ can be used to determine probability of an electron being at a particular point/region of an atom, from which a ground state can be inferred, and further determine probability of reaction between a first atom/molecule and a second atom/molecule. The diagonalization of the Hamiltonian H in a subspace defined by a subset of electronic configurations is commonly referred to as Selected Configuration Interaction (SCI), and can be performed by a SCI component 119 on classical computer 150 (per FIG. 1, as further described).

Per the foregoing, quantum computer 110 generates the quantum state |Q [symbol] in charge of producing the correct set of electronic configurations χ to describe the desired eigenstate, e.g., with the relevant degrees of freedom, with the classical computer 150 utilizing the electronic configurations χ to determine one or more properties of electron/atom/molecule of interest.

At (5), furthermore, the Hamiltonian His particle number preserving (e.g., U(1) symmetry) for each spin sector. Therefore, the Hamming weight of every configuration x ∈ χ is fixed, such that the total number of 0's and 1's in each bit string l is known/constant, accordingly, the Hamming weight can be referenced as a particle number and denoted by the symbol N. The procedure presented in FIG. 11 can be straightforwardly generalized to the case where groups of bits in each configuration are required to have fixed Hamming weights.

### QSCI in a Noisy Environment

As previously mentioned, while QSCI process 112 can provide a prediction/probability of electron position, successful implementation of the conventional QSCI process 112 presented in FIG. 11 can be compromised with the presence of noise 105 in the quantum computing system 110. When noise 105 is present, the ideal distribution P_{Q}(x) can be altered, producing a wrong distribution \tilde{P}_{Q} (x). Accordingly, what may previously have been a set χ of sampled noiseless configurations x, in the presence of noise 105, the set of noiseless configurations χ may become a set of noisy configurations \tilde{X}, where

x={x|x˜\tilde{P}_{Q}(x)}.

In a scenario where the amount of noise 105 in the quantum computing system 110 is small, the noiseless distribution P_{Q}(x) and noisy distribution P_{Q}(x) may not differ significantly from each other, and the Hamiltonian H diagonalization procedure implemented on the classical computer 150 can mitigate small errors resulting from the low level of noise 105. Accordingly, a ground state determined from the set of low-level noise configurations \tilde{x} may be sufficiently accurate for determination of a reaction of the system being analyzed.

However, in the presence of moderate or greater amounts of noise 105, P_{Q}(x) and \tilde{P}_{Q}(x) may be sufficiently different from each other such that the conventional QSCI process 112 becomes inaccurate, increasingly so as the amount of noise 105 in the quantum computer 110 increases further. In particular, in a situation of where P_{Q} (x) and \tilde{P}_{Q}(x) do not share the same support, the conventional QSCI process 112 can be prone to producing inaccurate results, and accordingly, inaccurate measures of the ground state properties.

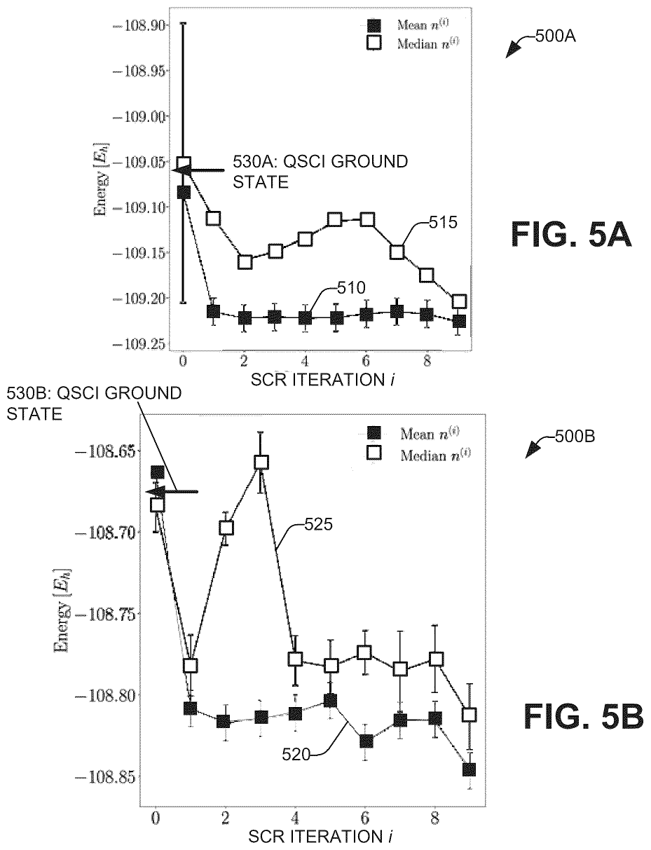

The various embodiments presented herein relate to at least one recovery technique/method/technology to reduce the effect of system noise 105 on the QSCI process 112. Application of a conventional QSCI process 112 on medium to large quantum processors 110 will not produce reliable predictions in near-term devices. In the N₂ example presented in FIGS. 5A-5D, with a system comprising 26 qubits, less than 2% of the noisy samples coincide with the noiseless samples x.

### SCR Process Overview

The following provides an overview of the various embodiments presented herein, whereby the various embodiments can be collectively referred to as a self-consistent configuration recovery (SCR) process. The various embodiments presented herein are configured for application with a conventional QSCI process 112 (e.g., as depicted in FIG. 11). The various embodiments presented herein enable recovery of noisy configurations back to their ideal noiseless configurations. Accordingly, the various embodiments enable recovery of configurations from the noiseless P_{Q} (x), that are not present, or appear with low probability in \tilde{P}_{Q}(x), thereby improving the predictive ability of the QSCI process 112.

As further described, in an embodiment, a reference vector of spin-orbital occupancies can be provided. In another embodiment, a value of n is not provided but can be computed from the SCI process 119, per the one or more embodiments presented herein, bit-flips can be performed for every electronic configuration x ∈\tilde{X} that has the wrong particle number N, enabling the recovery of n from

$$\vert ψ 〉 = {\sum }_{x ∈ χ} {ψ}_{x} \vert x 〉 .$$

For example, if it is known that the number N of occupied spin-orbitals in a system is known to be 10 but the sample r has 8 (e.g., 8 spin orbitals have occupancy |1 [symbol] , it is known that two of the spin orbitals identified as empty (e.g., computational basis |0) are to be bit-flipped to achieve a N of value of 10. Alternatively, if the initial condition of occupied spin-orbitals N is 13 (rather than the expected N=10), then 3 of the spin orbitals identified as being occupied are to be bit-flipped from an occupancy state |1) to an empty state 0) to achieve an occupied spin-orbitals N value of 10.

Where the value of n is not assumed to be known in advance, n can be computed self-consistently from |ψ). An initial value for n can also be computed from classical approximate numerical many-body calculations.

Per the various embodiments presented herein, two different approaches to calculate n from |ψ) are further described: a) utilizing the mean occupancies, and b) utilizing the median occupancies.

Further, given a configuration x that is in the support of P_{Q}(x), a lower bound to the probability that the SCR procedure 120 will recover the sample x is provided, wherein the lower bound can be a function of, in a non-limiting list, the amount of device noise 105 in quantum processor 110, the shape of n, the number of qubits M, the number of electrons, the dissimilarity in bit string length between x and n, and suchlike.

The various embodiments presented herein enable numerous advantages over a conventional QSCI process 112. For example, identification/determination of noiseless configurations (107A-n) from their noisy counterparts can be conducted, via SCR process 121, utilizing a combination of quantum computers 110 and classical computers 150 in an efficient/expedited manner compared to utilizing the QSCI process 112/SCI process 119 alone. Further, one or more ground states of an atom/molecule/system 102 can be determined that are closer to an actual ground state of the system 102, enabling improved accuracy of determination of interaction of the system 102 with other systems/molecules/atoms. As further described, the computational budget of implementing the SCR process 121 is less than the computational overhead of the conventional QSCI process 112, particularly in view of the accuracy of prediction is enhanced with the SCR process 121. Further, per the iteration process presented herein, whereby a first ground state determined by a first iteration of the SCR process 121 can be subsequently fed back into the SCR process 121 to determine a second ground state, and so on, enabling the ground state to be determined with a high degree of probability in relatively few iterations (e.g., five iterations). Per the various embodiments presented herein, the SCR process 121 enables recovery of correct configurations from these noisy samples, facilitating improved/high accuracy results from the conventional QSCI process 112, particularly where the simulation of larger molecular systems (described by a larger number of orbitals in a configuration x) requires the use of more qubits and deeper circuits, thus increasing the amount of noise 105 in the quantum processor 110.

### The SCR Process

FIG. 1, system 100 illustrates implementation of a SCR process to determine the ground state properties of an electron/atom/molecule, in accordance with an embodiment.

As previously mentioned with reference to FIG. 11, a quantum computer 110 can utilize a QSCI process 112A to generate a quantum state |Q [symbol] , for which a set of configurations X are generated as a function of noise 105 in the quantum computer 110. The set of configurations \tilde{x} can be transmitted to/received by the classical computer 150. Classical computer 150 can include a SCI component 119 configured to perform the previously mentioned SCI operations (e.g., diagonalization of Hamiltonian H), and also a probability component 118 configured to perform the respective probability operations associated with the QSCI process 112, as previously mentioned.

Classical computer 150 can also include a SCR component 120 which can be configured to process (e.g., via SCR process 121) the set of noisy configurations \tilde{x}. The SCR component 120 can include an iteration component 127 configured to perform the respective iterations i, as further described. SCR component 120 can further include a criteria component 124 configured to receive and implement one or more criterions/criteria 125 regarding whether a further iteration i is to be performed or the SCR process 121 can be terminated/ceased. In an embodiment, the criteria component 124 can receive a criterion 125 (e.g., from an entity observing the QSCI process 112/SCR process 121). Any suitable criterion 125 can be utilized, e.g., value is approaching a target value, value convergence, and suchlike, as further described.

As further shown, classical computer 150 can further include a memory 184 that stores the respective computer executable components (e.g., SCR process component 120, SCR process 121, configuration component 126, iteration component 127, criteria component 124, and suchlike) and further, a processor 182 configured to execute the computer executable components stored in the memory 184. Memory 184 can be further configured to store any of the configurations x received in χ and \tilde{x}, information regarding which bits in a configuration x were adjusted/flipped, particle number N and suchlike received/generated/utilized during implementation of the SCR process 121). The computer system 150 can further include a human machine interface (HMI) 186 (e.g., a display, a graphical-user interface (GUI)) which can be configured to present various information including configurations 107A-n, iterations i, ground state, status of criteria 125, and suchlike, per the various embodiments presented herein. HMI 186 can include an interactive display/screen 187 to present the various information. Computer system 150 can further include an I/O component 188 to receive and/or transmit respectively configurations 107A-n, ground state energies, stop criteria 125, and suchlike.

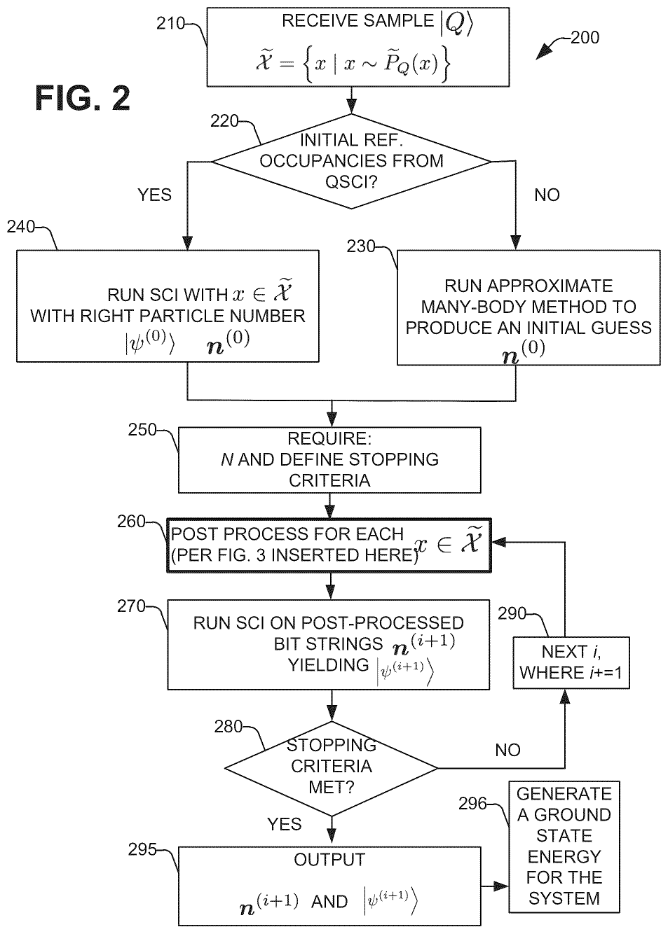

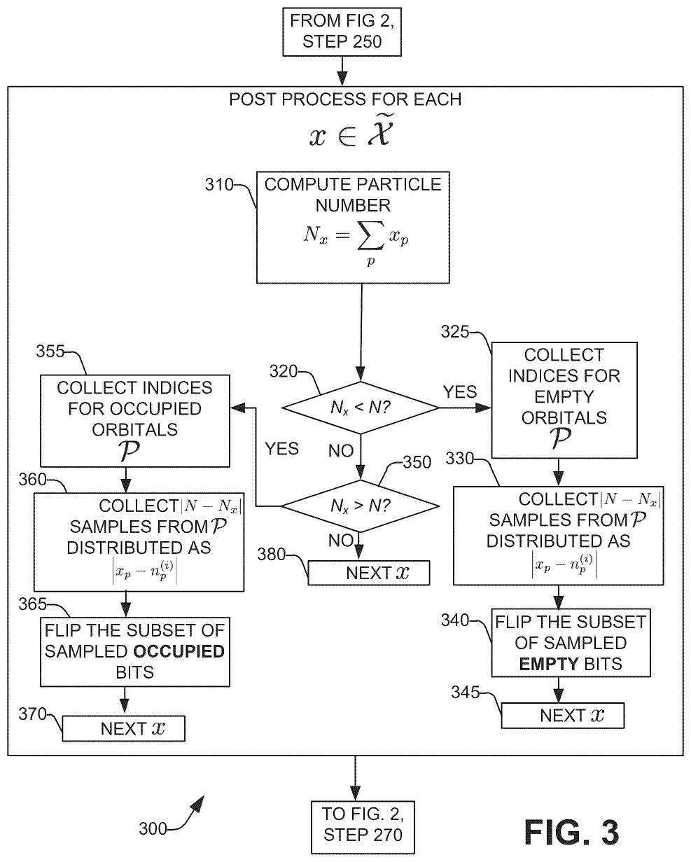

FIG. 2, process 200 illustrates a computer-implemented process for determining a ground state of an electron/atom/molecule, in accordance with an embodiment. FIG. 3, process 300 illustrates a computer-implemented process for post-processing a sample configuration in a set of noisy configurations, in accordance with an embodiment, wherein process 300 forms a subprocess of process 200.

At 210, similar to step (1) described in FIG. 11, a quantum state |Q) is prepared in a quantum processor 110. Quantum noise 105 is present in the quantum processor 110 which gives rise to configurations x that may be affected by the noise 105 such that one or more bits in the configuration x may (a) comprise of incorrect values for the spin-orbital occupancies described by the bit string x, (b) the total number of spin-orbital occupancies may be incorrect, and suchlike. An SCR process 121 is implemented to identify the noisy bit strings and correct them to generate a correct noiseless bit string configuration.

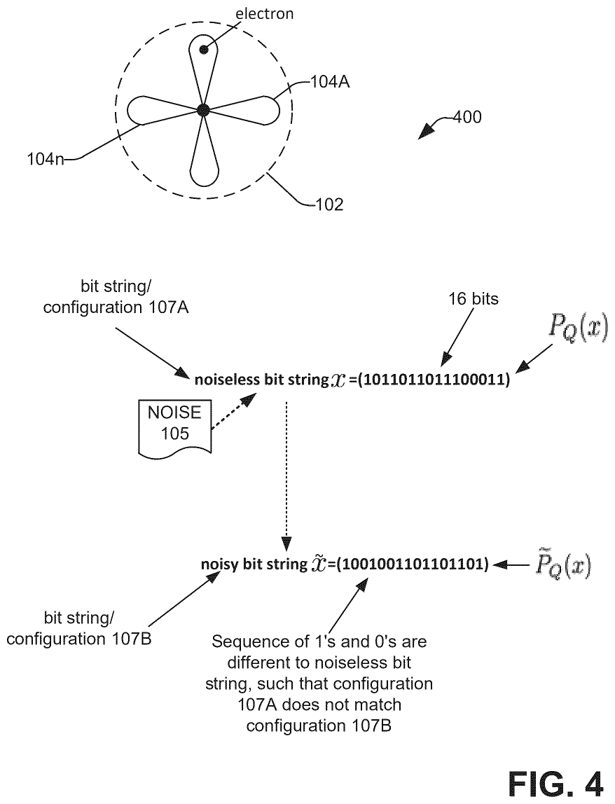

Turning momentarily to FIG. 4, schematic 400, the respective components of a configuration x are presented, and the effect of quantum noise thereon, in accordance with an embodiment. As shown, a noiseless bit string x/107A, can represent a system (e.g., molecule 102) and the respective spin orbitals (e.g., orbitals 104A-n). When no noise 105 is present in a quantum system 110, configuration 107A/x comprises, for example, a sequence of 16 bits and a noiseless probability distribution of P_{Q}(x). However, with the introduction of noise 105, the noiseless bit string x may become a noisy bit string x/107B where the sequence of 1's and 0's in the 16 bits is different to the sequence in the 16 bits of bit string x, with a noisy probability distribution of \tilde{P}_{Q}(x). Hence, noise 105 has affected the bit string x, and further leads to uncertainty regarding effects of noise 105 and content of any sets of samples \tilde{x} comprising bit string x.

Further at 210, a set of noisy samples

x={x|x˜\tilde{P}_{Q}(x)}

are generated by the quantum computer 110 and received by the classical computer 150, wherein the noisy samples \tilde{x} are obtained from projective measurements of quantum state Q) in the computational basis (e.g., 0↔empty, and 1↔occupied, as previously mentioned). Classical computer 150 can include a SCR component 120 configured to process the noisy samples X, wherein the SCR component 120 can operate in conjunction with the QSCI process 112 and SCI component 119.

SCR component 120 can include a configuration component 126, wherein configuration component 126 can be configured to process bit strings x, noisy samples \tilde{x}, etc., to enable the removal of the effects of noise 105 on the noisy samples \tilde{x} SCR component 120 can further include an iteration component 127, wherein the iteration component 127 can be configured to step through iterations i to obtain the ground state.

At 220, an initial determination/guess for the initial reference occupancies n⁽⁰⁾ in a configuration x can be generated by configuration component 126. Further, iteration component 127 can include a self-consistent step counter, which can be set at an initial value i=0.

The reference occupancies n⁽⁰⁾ can be determined by the configuration component 126 from:

at 230, in response to a determination that NO, reference occupancies n⁽⁰⁾ are not to be obtained from the QSCI process 112, the reference occupancies n⁽⁰⁾ can be generated by configuration component 126 by an approximate many-body calculation, and/or

at 240, in response to a determination that YES, reference occupancies n⁽⁰⁾ are to be obtained from the QSCI process 112, configuration component 126 can run the previously described QSCI process 112 (e.g., via SCI component 119) on the subset of noisy configurations x in the set of noisy samples X, having the right particle number N, to generate the initial reference occupancies n⁽⁰⁾.

Respective operations at steps 230/240 can advance to step 250, whereby the respective number N of electrons in configuration(s) x and the stopping criteria 125 can be defined (e.g., received and processed by criteria component 124).

At 260, each noisy configuration X ∈\tilde{X} can be post-processed by the configuration component 126 according to the following procedure (turning to FIG. 3):

At 310, in the event of the post-processed configuration x represents an electronic configuration with more (or less) electrons than the correct number of electrons N, then the number of electrons in a noisy configuration x is given by

$${N}_{x} = {\sum }_{p} {x}_{p} .$$

Operations 320-370 can entail the indices for the occupied (or empty) orbitals in post-processed configuration X being collected/obtained/determined based on whether Nₓ is less than (step 320) or greater than (step 350) N. At 325 and 355, the collected indices form the set [symbol] , whereby at 330 and 360, the number |N−N_{z}. of samples can be generated from [symbol] without replacement, following the distribution proportional to |xₚ−n_{P}⁽ⁱ⁾|, where P ∈ [symbol] .

At 340, the subset of sampled empty bits in configurations x can be flipped, while, in the alternative, at 365, the subset of sampled occupied bits in configurations x can be flipped.

Returning to FIG. 2, step 270, the SCI process 119 can be initiated/performed utilizing the post-processed configurations x generated from step 260/FIG. 3 Steps 310-380 [symbol] above, producing the approximation to the target eigenstate |ψ⁽ⁱ⁺¹⁾ [symbol] . The iteration component 127 can be advanced such that the spin-orbital reference occupancies n⁽ⁱ⁺¹⁾ for the next iteration i+1 can be obtained from |ψ⁽ⁱ⁺¹⁾ [symbol] .

At 280, the criteria component 124 can be configured to determine whether a stop condition 125 has been met. Stop condition 125 can be a value convergence operation comprising comparing the result of a prior iteration i with the result of a current iteration i+1 (per FIGS. 5A-5D) At 280, in the event of a determination by the criteria component 124, that NO, the stopping criteria 125 has not been met, the iteration component 127 can be advanced i+=1 (at step 290), and the process flow 200 can be configured to return to step 260.

At 280, in response to a determination by the criteria component 124, that YES, the stopping criteria 125 has been met, process 200 can advance to step 295, whereupon the respective values of n⁽ⁱ⁺¹⁾ and |ψ⁽ⁱ⁺¹⁾ [symbol] can be generated/output by the configuration component 126 (e.g., via I/O component 188) which can be further utilized, at 296, to determine the ground state/eigenstate of system 102 (e.g., as previously described with regard to FIG. 11).

Returning to FIG. 3, step 380, in the event of Nₓ=N, the process can advance to step 270, as previously described.

### Effect of Computational Budget on Implementing a SCI Process

When applying the SCI process 119 to a set of configurations x, the number of configurations X that can be included/processed in an SCI step (per steps 240 and 270 of FIG. 2) is limited by the available computational budget/cost required by the SCI component 119 of the classical computer 150, per the following:
a) in an embodiment, in the event of the number of unique configurations x in the set of configurations \tilde{x} is less than/equal to the available computational budget at classical computer 150, all of the unique configurations X can be included in a calculation utilizing SCI process 119.
b) in another embodiment, in the event of the number of unique configurations X in the set of configurations \tilde{x} is greater than the available computational budget at classical computer 150, then the set of configurations x can be subsampled (e.g., by configuration component 126) to produce respective configuration subsamples SS, wherein each configuration subsample in the collection of configuration subsamples are configured with a sample size amenable to implementation of the SCI process 119, whereby the SCI process 119 is applied to each respective configuration subsample. In an embodiment, the configuration subsample can be obtained (e.g., by configuration component 126) by sampling the set of configurations \tilde{x} according to the frequency of each electronic configuration, whereby:
a) a number of sets of configuration subsamples must be considered to collect statistics on the energy and reference occupancy to be used in the next SCR process 121 step; and/or
b) an error-bar may be obtained for observables as the statistical error from different sets of subsamples.

### Mean Occupancies and Median Occupancies

As previously mentioned, two different approaches can be utilized by the configuration component 126 to calculate/extract n⁽ⁱ⁾ from |ψ⁽ⁱ⁾ [symbol] A first approach utilizes the mean spin-orbital occupancies, and a second approach utilizing the median spin-orbital occupancies.

When utilizing the mean occupancy approach, the configuration component 126 can be configured to compute from the expectation value

$${n}_{p}^{( i )} = 〈 {ψ}^{( i )} \vert {c}_{p}^{†} {c}_{p} \vert {ψ}^{( i )} 〉 = {\sum }_{x ∈ χ} {\vert {ψ}_{x} \vert}^{2} {x}_{p} .$$

When utilizing the median occupancy approach, the configuration component 126 can be configured to compute nₚ⁽ⁱ⁾ per the following:
i) configuration component 126 is configured to identify the subset [symbol] p⊂χ of electronic configurations where spin-orbital p is occupied (e.g., configuration is 1↔occupied), then

[symbol]

ₚ={|x∈χ and xₚ=1};
ii) the set of scaled wave function amplitudes,

Sₚ={| [symbol] ₚ∥ψₓ|2|x∈ [symbol] ₚ}

is defined by the configuration component 126;
iii) accordingly, the following can be applied the configuration component 126:

nₚ⁽ⁱ⁾=min(1,median|Sₚ|);

and/or
iv) the resulting n⁽ⁱ⁾ can be scaled by the configuration component 126 to have the right particle number:

$${n}^{( i )} \to \frac{N {n}^{( i )}}{{\sum }_{p} {n}_{p}^{( i )}} .$$

### Example Implementation: Recovering Electronic Configurations of an N₂ Molecule

FIGS. 5A and 5B respectively present charts 500A and 500B for recovering electronic configurations, in accordance with an embodiment. Charts 500A and 500B present examples of recovering electronic configurations/ground state of a nitrogen N₂ molecule (a diatomic molecule), with an according change in the determined energy (e.g., in mEₕ(milliHartree energy)) over a series of SCR iterations, per the various embodiments presented herein. The N₂ molecule can be described by 26 spatial orbitals, such that number of qubits, M, is 52.

In the examples presented in FIGS. 5A and 5B, quantum state |Q [symbol] , which is defined in the seniority-zero subspace, was prepared with quantum computing system 110 comprising an Eagle IBM Q processor. With a seniority-zero subspace, the number of qubits M should equal the number of spatial orbitals N, whereby, as the determined energy of the ground state reduces/decreases/lowers, the more accurate the prediction of ground state becomes. As shown, the ground state of the system/energy of the N₂ molecule is being targeted (per the y-axis Hartree Energy (Eₕ)), whereby the arrows 530A and 530B respectively indicate the ground state estimates from application of the conventional QSCI process 112 (per FIG. 11) without the SCR process 121. Accordingly, FIGS. 5A and 5B indicate the improvements in recovering an electronic configuration/ground state based on implementing the various embodiments presented herein regarding implementing the QSCI process 112 with the SCR process 121 versus the ground state estimates derived with a conventional QSCI process 112 only.

The respective results/measurements/computations for the energy presented in FIGS. 5A and 5B are as determined for two different bond lengths, whereby chart 500A presents the results/measurements with a bond length of 1.0 Angstroms being utilized, e.g., a close to equilibrium situation respectively utilizing the mean occupancies process (line 510) and median occupancies process (line 515). Further, chart 500B presents the results/measurements with a bond length of 3.0 Angstroms applied, e.g., a stretched bond/further away from equilibrium scenario, utilizing the mean occupancies process (line 520) and median occupancies process (line 525). As shown in FIGS. 5A and 5B, a total of ten iterations i were respectively performed for the SCR processes 121.

As shown in FIGS. 5A and 5B, over the course of performing the respective iterations i, the estimate for the ground state (derived by the SCI process(es) presented herein) decreases, and further, the ground state estimates have energy values (per lines 510, 515, 520, and 525) less than the ground state estimates (per arrows 530A and 530B) obtained from the conventional QSCI process 112. Accordingly, it is apparent that the one or more embodiments presented herein regarding implementing a SCR process 121 show improvement over the ground state predictions provided by QSCI process 112 alone.

In the examples provided regarding the N₂ molecule, the median occupancies process (per lines 515 and 525) to determine n⁽ⁱ⁾ performed worse than n⁽ⁱ⁾ determined from the mean occupancies process (per lines 510 and 520), e.g., the predicted ground state energies presented in lines 510 and 520 are lower than those predicted in lines 515 and 525.

As shown in FIGS. 5A and 5B, the estimate for the ground state energy decreases with the number of self-consistent iterations i, thus providing a more accurate representation of the ground state than obtained from simply applying the QSCI process 112. As shown, the various embodiments presented herein improved the prediction accuracy of the ground state by 200 mEₕ (milliHartree energy), per lines 510, 515, 520, and 525, compared with the ground state energies derived by the QSCI process 112 (as indicated by arrows 530A and 530B). As previously mentioned, the mean and median occupancy approaches (per lines 510, 515, 520, and 525) starts with an assumption that the set of reference occupancies n are not known but are initially obtained from the noisy data sample. Accordingly, during initial iterations i, the “guess” of what the reference occupancies n will be is accordingly incorrect/inaccurate. However, as shown in FIGS. 5C and 5D, as further iterations i are performed, the estimation of the vector of reference occupancy n of spin-orbitals in spin orbital bit string X improves, as illustrated by the converging Hartree energy values in the later performed iterations i of lines 515 and 525.

FIGS. 5C and 5D respectively present charts 500C and 500D for recovering electronic configurations, in accordance with an embodiment. Charts 500C and 500D pertain to the same examples as 500A and 500B regarding recovering electronic configurations/ground state of a nitrogen N₂ molecule (a diatomic molecule), with an according change in the determined energy (e.g., in mEh) over a series of SCR iterations, per the various embodiments presented herein. The N₂ molecule can be described by 26 spatial orbitals, such that the number of qubits, M is 52.

FIG. 5C depicts the values of the entries of the vector of reference occupancies n over a series of iterations for a 1.0 Angstrom bond length N₂ molecule, such that as shown, an initial iteration (first line having symbols o) of a ground state wave function, a first iteration (a second line having symbols [symbol] ) of a ground state wave function, and a tenth iteration (a third line having symbols [symbol] ) of a ground state wave function. As shown, as the respective iterations are performed, the probability of an electron being found in an occupied spin orbital of 1 (an occupied spin orbital) or 0 (an unoccupied spin orbital) is resolved and improved. As previously mentioned, after the initial ground state wave function (first line having symbols o) is determined, the initial vector of reference occupancies n⁽⁰⁾ is reapplied to the SCR/SCI process depicted in FIGS. 2 and 3, with each iteration of the SCR/SCI process generating a subsequent ground state wave function that generates another vector of reference occupancies n⁽ⁱ⁺¹⁾ that can be further reapplied to the SCR/SCI process, such that the first iteration of the ground state wave function is generated from the initial vector of reference occupancies n⁽⁰⁾, and further the tenth iteration of the ground state wave function is generated from the ninth vector of reference occupancies n⁽⁹⁾ derived at the ninth SCR step. A convergence criterion 125 can be satisfied as the respective location of 0's and 1's in a first configuration (e.g., a configuration 107R) matches the respective location of 0's and 1's in a second configuration (e.g., a bit-flipped configuration 1075), wherein the second configuration is generated subsequent to the first configuration.

FIG. 5D depicts the values of the entries of the vector of reference occupancies n over a series of iterations for 3.0 Angstrom bond length N₂ molecule, which similarly presents the ground state wave function stabilizing/resolving.

### Analysis Regarding Probability of Recovering Bits in the Support of Noiseless Distribution

The following presents an analysis of the probability of recovering a noiseless bit string x that is present in the quantum system 110, but is effectively lost as a function of quantum noise 105. In the following, the worst case scenario of implementing the QSCI process 112 is used, that of a global depolarizing noise channel present at the quantum system 110. Accordingly, the initial condition comprises a noiseless probability distribution P_{Q}x is mixed in with completely random, noisy bit string samples. In the following, P_{Q}(x) is proportional to a. The noisy distribution \tilde{P}_{Q}(x) over a series of random samples/configurations is given by:

$${\tilde{P}}_{Q} ( x ) = α {F}_{Q} ( x ) + ( 1 - α ) \frac{1}{{2}^{M}}$$

where, M=number of qubits, N=number of electrons, D=circuit depth, α=^{C}D where C=some constant, and a can have a valve of 0 through to 1. When α=1, all of the signal/samples come from a noiseless probability distribution P_{Q}(x) (e.g., having a perfect probability distribution). When α=0, all of the signal/samples come from a completely noisy, random probability distribution such that the contribution from the noiseless probability distribution P_{Q}(x) is zero and only quantum noise 105 is present/visible.

In an aspect, an assumption is made, e.g., in accordance with calculating ground state energies of molecules, that the probability distribution P_{Q}(x) is concentrated around/have a lot of weight in the “Hartree-Fock” configuration

$$x = {\underbrace{111 … 1}}_{N} {\underbrace{000 … 0}}_{M - N} ,$$

where, as shown, the N (number of electrons) entries in bit string V are 1 and the entries M-N(e.g., number of qubits-number of electrons) are 0.

P_{Q}(x) rapidly decreases as a function of the Hamming distance between bit string X and the Hartree-Fock configuration. This is an implicit assumption of the QSCI process 112, otherwise no compact representation of the ground state wave function exists. This situation is common in electronic-structure calculations regarding electrons, atoms, molecules, etc.

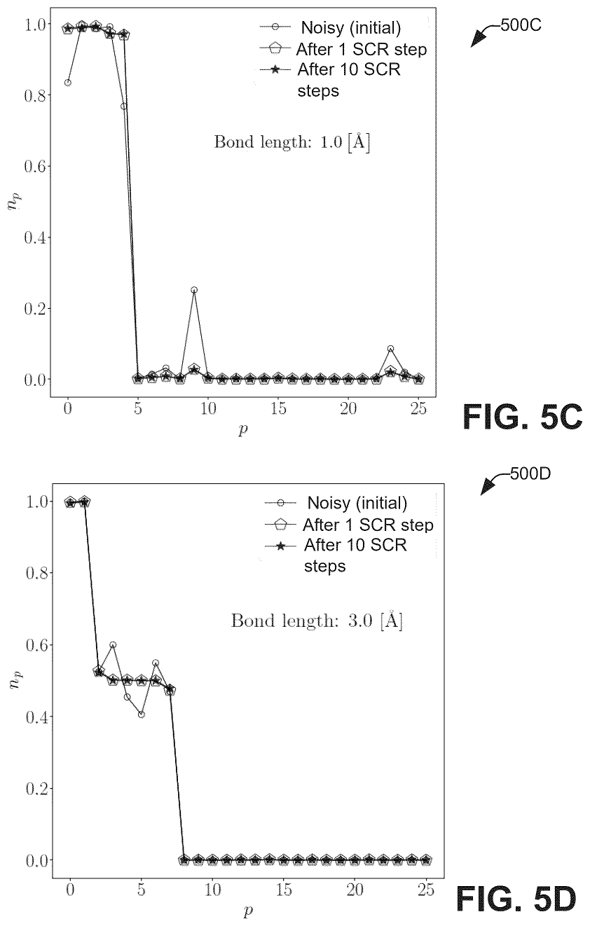

FIG. 6, graph 600 illustrates respective distances of from boundary conditions of occupied (1) and empty (0) spin-orbitals, in accordance with an embodiment. Consequently, as represented in FIG. 6, it can be assumed that the components of the reference occupancies are on average ε«1 away from 0 or 1, presenting a correlation between nₚ and where a bit string x comprises occupied (1) and empty (0) spin-orbitals. In an aspect, the intersection of the x-axis and the y-axis can represent the nucleus, such that as the radial distance RD of the spin-orbital increases, the probability of an electron being in a first spin-orbital (e.g., in N) that is closer to the nucleus is greater than the probability of an electron bring in a second spin-orbital (e.g., in M-n) that is further away from the nucleus.

Without loss of generality, it can be assumed that N≤; M/2, such that, if the assumption is not the case, particles (p) may be replaced by holes (h), as further described.

For example, consider a configuration x that is in the support of P_{Q}(x) and whose Hamming distance to the Hartree-Fock configuration is 2b.

The probability that configuration χ can be recovered from samples from the uniform distribution by the SCR process 121, presented herein, is lower bounded by:

$${P}_{recovery} ( x ) \geq {\sum }_{a = 1}^{N - b} \frac{1}{( \begin{matrix}a + b \\ a\end{matrix} )} \frac{{π}_{p} ( a , ε ) ( \begin{matrix}n - b \\ a\end{matrix} ) + {π}_{h} ( a , ε ) ( \begin{matrix}M - N - b \\ a\end{matrix} )}{{2}^{M}} , \\ where :$$

$${π}_{p} ( a , ε ) = \frac{{( 1 - ε )}^{a}}{{( 1 - ε )}^{a} N {ε}^{a}} ( e . g . , particles , occupied spin ‐ orbitals ) , and \\ {π}_{h} ( a , ε ) = \frac{{( 1 - ε )}^{a}}{{( 1 - ε )}^{a} + ( M - N ) {ε}^{a}} ( e . g . , holes , empty spin ‐ orbitals ) .$$

The noisy sampled probability RQ(V) can then be corrected as:

$${\tilde{P}}_{Q} ( x ) = α {P}_{Q} ( x ) + ( 1 - α ) \frac{1}{{2}^{M}} {\to }^{SCR} {P}_{SCR} ( x ) \\ where : \\ {P}_{SCR} ( x ) = \{ \begin{matrix}0 if {\sum }_{p} {x}_{p} \neq N \\ α {P}_{Q} ( x ) + ( 1 - α ) {P}_{recovery} ( x ) as generated from the SCR process\end{matrix}$$

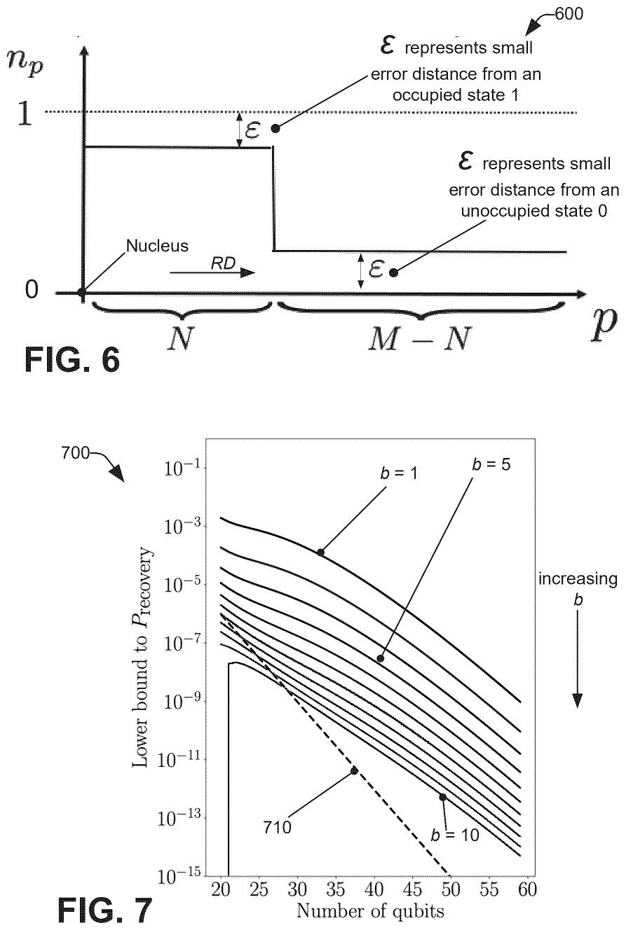

The foregoing illustrates that in the simple noise model presented in FIG. 6, the SCR process 121 strictly improves the probability of obtaining the correct configurations. A numerical illustration of the foregoing is presented in FIG. 7.

FIG. 7, chart 700 is a log-linear plot of the probability of recovery of a configuration as a function of the number of qubits, in accordance with an embodiment.

FIG. 7 illustrates the lower bound to P_{recovery}(x) for different values of b as represented by the lines indicating b=1, b=5, b=10, as a function of the number of qubits M. Selected values ε=0.1, and N=10 are implemented in FIG. 7.

The dashed line 710 shows the value of ½^{M} for reference, which is the recovery probability when sampling from the uniform distribution. Line 710 indicates the probability of recovering a desired bit string is simply sampling from noise, such that bit strings were being randomly selected based on a bit string length satisfying a required number of qubits. As shown in FIG. 7, application of the SCR process 121 enables a higher probability of identifying the noiseless configurations x.

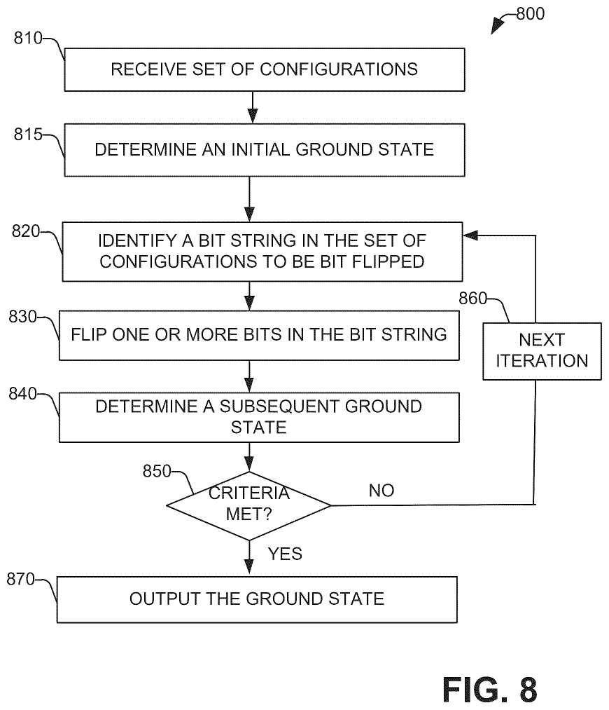

FIG. 8, process 800 illustrates a computer-implemented process for determining a ground state of an electron/atom/molecule, in accordance with an embodiment.

At 810, a set of configurations \tilde{X} can be generated by a quantum computer (e.g., by quantum computer 110), wherein the set of configurations \tilde{X} pertain to a system (e.g., one of an atom, a molecule, and suchlike, e.g., molecule 102) for which a ground state is being determined. In an embodiment, the quantum computer is experiencing unwanted noise (e.g., quantum noise 105) such that the set of configurations \tilde{X} includes one or more configurations x affected by the noise.

At 815, a first Hamiltonian H₁ can be generated from the initial set of configurations \tilde{X}, and further, the first Hamiltonian can be diagonalized (e.g., by SCI component 119) to generate a first ground state (e.g., GS₁)—wherein the first ground state represents the ground state of the noisy system.

At 820, a first configuration (e.g., first configuration 107A) in the set of configurations A is identified, wherein the first configuration comprises a bit string, wherein the bit string identifies respective spin-orbitals in which an atomic particle in the system may be located. As previously mentioned, a spin-orbital can have a value of 0 if the spin-orbital has a high probability of being unoccupied or a value of 1 if the spin-orbital has a high probability of being occupied. In an embodiment, the first configuration can be identified as a function of the bit string comprises a number of spin-orbitals matching an expected number of spin-orbitals, however the actual sequence of 0's and 1's may be erroneous as a function of the quantum noise.

At 830, the first configuration can be modified, e.g., a first bit in the bit string can be flipped (e.g., a 0 to 1, or 1 to 0).

At 840, the set of configurations \tilde{X} can be updated to include the modified configuration x. A second Hamiltonian H₂ can be generated from the updated set of configurations \tilde{X}, whereby the second Hamiltonian can be diagonalized (e.g., by SCI component 119) to generate a second ground state (e.g., GS₂).

At 850, the first ground state and the second ground state can be compared (e.g., by criteria component 124) in accordance with a stopping criteria (e.g., criteria 125). In response to a determination that the first ground state and the second ground state do not comply with the stopping criteria (e.g., values for GS₁ and GS₂ are not converging sufficiently), process 800 can advance to step 860 where a subsequent iteration (e.g., a configuration x is further bit flipped) can be performed and process 800 returns to step 820 for further bit flip operation(s) to be performed.

At 850, in response to a determination that the first ground state and the second ground state do comply with the stopping criteria (e.g., values for GS₁ and GS₂ are converging sufficiently), process 800 can advance to step 870 where the second ground state can be output as the ground state of the system.

As previously mentioned, QSCI process 112 is a promising near-term algorithm/process to tackle medium to large molecular systems. However, the presence of moderate to large amounts of noise 105 in quantum processor 110 can render the QSCI process 112 unusable because the proportion of the sampled configurations that come from the correct distribution vanishes. Per the various embodiments presented herein, the SCR process 121 enables recovery of correct configurations from these noisy samples, facilitating improved/high accuracy results from the conventional QSCI process 112.

The simulation of larger molecular systems (described by a larger number of orbitals in a configuration x) requires the use of more qubits and deeper circuits, thus increasing the amount of noise 105 in the quantum processor 110. The various embodiments presented herein enables the use of noisy quantum processors 110 to simulate medium to large systems of interacting fermions with concentrated wave functions.

It is to be appreciated that while the forgoing embodiments are described with regard to identifying probability of location of an electron, the various embodiments can be equally applied to fermions, bosons, atomic nuclei, systems of spins, and suchlike.

### Example Applications and Use

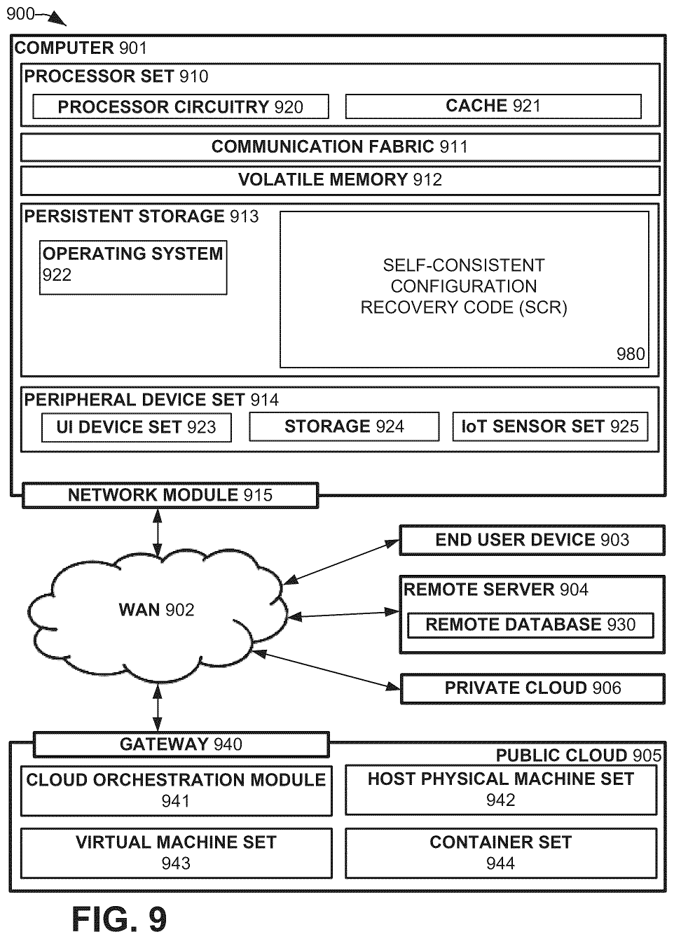

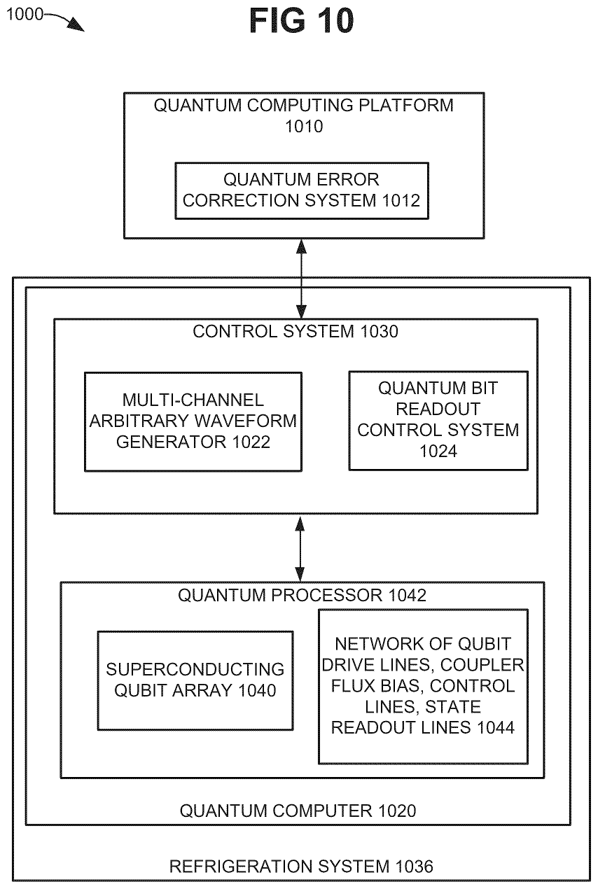

FIGS. 9 and 10 and the following discussion are intended to provide a brief, general description of a suitable computing environments 900 and 1000 in which one or more embodiments described herein at FIGS. 1-8 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code involved in performing the inventive methods, such as automatically determining a ground state from one or more configurations x/107A-n that may have been affected by quantum noise 105, via the application of SCR code 980 (e.g., having the functionality of one or more components of SCR component 120/SCR process 121). In addition to block 980, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 980, as identified above), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method can be distributed among multiple computers and/or between multiple locations. On the other hand, in this presentation of computing environment 900, detailed discussion is focused on a single computer, specifically computer 901, to keep the presentation as simple as possible. Computer 901 can be located in a cloud, even though it is not shown in a cloud in FIG. 9. On the other hand, computer 901 is not required to be in a cloud except to any extent as can be affirmatively indicated.

PROCESSOR SET 910 includes one, or more, computer processors of any type now known or to be developed in the future. Processing circuitry 920 can be distributed over multiple packages, for example, multiple, coordinated integrated circuit chips. Processing circuitry 920 can implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set can be located “off chip.” In some computing environments, processor set 910 can be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods can be stored in block 980 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory can be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 can be a read only memory (ROM), but typically at least a portion of the persistent storage allows writing of data, deletion of data and re-writing of data. Some familiar forms of persistent storage include magnetic disks and solid-state storage devices. Operating system 922 can take several forms, such as various known proprietary operating systems or open-source Portable Operating System Interface type operating systems that employ a kernel. The code included in block 980 typically includes at least some of the computer code involved in performing the inventive methods.

PERIPHERAL DEVICE SET 914 includes the set of peripheral devices of computer 901. Data communication connections between the peripheral devices and the other components of computer 901 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 923 can include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 can be persistent and/or volatile. In some embodiments, storage 924 can take the form of a quantum computing storage device for storing data in the form of qubits. In embodiments where computer 901 is required to have a large amount of storage (for example, where computer 901 locally stores and manages a large database) then this storage can be provided by peripheral storage devices designed for storing large amounts of data, such as a storage area network (SAN) that is shared by multiple, geographically distributed computers. IoT sensor set 925 is made up of sensors that can be used in Internet of Things applications. For example, one sensor can be a thermometer and another sensor can be a motion detector.

NETWORK MODULE 915 is the collection of computer software, hardware, and firmware that allows computer 901 to communicate with other computers through WAN 902. Network module 915 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901) and can take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 can be a client device, such as thin client, heavy client, mainframe computer and/or desktop computer.

REMOTE SERVER 904 is any computer system that serves at least some data and/or functionality to computer 901. Remote server 904 can be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data can be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs can be stored as images and can be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware and firmware allowing public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the Figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

FIG. 10, presents a quantum computer system 1000, according to at least one embodiment, wherein computing system 1000 can comprise/be incorporated into quantum computer system 110. FIG. 10 schematically illustrates the quantum computing system 1000 which comprises a quantum computing platform 1010, a control system 1030, and a quantum processor 1042. In various embodiments, the quantum computing platform 1010 implements software control programs such as a software-based quantum error correction system 1012 to perform a quantum error correction processes, application of source code, etc., as well as perform other software-controlled processes such as qubit calibration operations. In other embodiments, the control system 1030 comprises a multi-channel arbitrary waveform generator 1022, and a quantum bit readout control system 1024. A quantum processor 1042 can comprise one or more solid-state semiconductor chips having one or more qubit arrays 1040 located thereon, and further a network 1044 of qubit drive lines, coupler flux-bias control lines, and qubit state readout lines, and other circuit QED components that may be needed for a given application or quantum system configuration.

In various embodiments, the control system 1030 and the quantum processor 1042 can be disposed in a dilution refrigeration system 1036 which can generate cryogenic temperatures that are sufficient to operate components of the control system 1030 for quantum computing applications. For example, the quantum processor 1042 may need to be cooled down to near-absolute zero, e.g., 10-15 millikelvin (mK), to allow the superconducting qubits to exhibit quantum behaviors. In some embodiments, the dilution refrigeration system 1036 comprises a multi-stage dilution refrigerator where the components of the control system 1030 can be maintained at different cryogenic temperatures, as needed. For example, while the quantum processor 1042 may need to be cooled down to, e.g., 10-15 mK, the circuit components of the control system 1030 may be operated at cryogenic temperatures greater than 10-15 mK (e.g., cryogenic temperatures in a range of 3K-4K), depending on the configuration of the quantum computing system.

In other embodiments, the qubit array 1040 comprises a quantum system of data/auxiliary qubits and qubit couplers. The number of qubits of the qubit array 1040 can be on the order of tens, hundreds, thousands, or more, etc. The network 1044 of qubit drive lines, coupler flux bias control lines, and qubit state readout lines, etc., are configured to apply microwave control signals to qubits and coupler circuitry in the qubit array 1040 to perform various types of gate operations, e.g., single-gate operations, entanglement gate operations (e.g., CPHASE gate operation), perform error correction operations, etc., as well read the quantum states of the qubits. For example, as noted above, microwave control pulses are applied to the qubit drive lines of respective qubits to change the quantum state of the qubits (e.g., change the quantum state of a given qubit between the ground state and excited state, or to a superposition state) when executing quantum information processing algorithms.

Furthermore, as noted above, the state readout lines comprise readout resonators that are coupled to respective qubits. The state of a given qubit can be determined through microwave transmission measurements made between readout ports of the readout resonator. The states of the qubits are read out after executing a quantum algorithm. In some embodiments, a dispersive readout operation is performed in which a change in the resonant frequency of a given readout resonator, which is coupled to a given qubit, is utilized to readout the state (e.g., ground or excited state) of the given qubit.

The network 1044 of qubit drive lines, coupler flux bias control lines, and qubit state readout lines, etc., is coupled to the control system 1030 through a suitable hardware input/output (I/O) interface, which couples I/O signals between the control system 1030 and the quantum processor 1042. For example, the hardware I/O interface may comprise various types of hardware and components, such as RF cables, wiring, RF elements, optical fibers, heat exchanges, filters, amplifiers, isolators, etc.

In some embodiments, the multi-channel arbitrary waveform generator (AWG) 1022 and other suitable microwave pulse signal generators are configured to generate the microwave control pulses that are applied to the qubit drive lines, and the coupler drive lines to control the operation of the superconducting qubits and associated qubit coupler circuitry, when performing various gate operations to execute a given certain quantum information processing algorithm. In some embodiments, the multi-channel AWG 1022 comprises a plurality of AWG channels, which control respective superconducting qubits within the superconducting qubit array 1040 of the quantum processor 1042. In some embodiments, each AWG channel comprises a baseband signal generator, a digital-to-analog converter (DAC) stage, a filter stage, a modulation stage, an impedance matching network, and a phase-locked loop system to generate local oscillator (LO) signals (e.g., quadrature LO signals LO_I and LO_Q) for the respective modulation stages of the respective AWG channels.

In some embodiments, the multi-channel AWG 1022 comprises a quadrature AWG system which is configured to process quadrature signals, wherein a quadrature signal comprises an in-phase (I) signal component, and a quadrature-phase (Q) signal component. In each AWG channel the baseband signal generator is configured to receive baseband data as input (e.g., from the quantum computing platform), and generate digital quadrature signals I and Q which represent the input baseband data. In this process, the baseband data that is input to the baseband signal generator for a given AWG channel is separated into two orthogonal digital components including an in-phase (I) baseband component and a quadrature-phase (Q) baseband component. The baseband signal generator for the given AWG channel can generate the requisite digital quadrature baseband IQ signals which are needed to generate an analog waveform (e.g., sinusoidal voltage waveform) with a target center frequency that is configured to operate or otherwise control a given quantum bit that is coupled to the output of the given AWG channel.

The DAC stage for the given AWG channel is configured to convert a digital baseband signal (e.g., a digital IQ signal output from the baseband signal generator) to an analog baseband signal (e.g., analog baseband signals I(t) and Q(t)) having a baseband frequency. The filter stage for the given AWG channel is configured to filter the IQ analog signal components output from the DAC stage to thereby generate filtered analog IQ signals. The modulation stage for the given AWG channel is configured to perform analog IQ signal modulation (e.g., single-sideband (SSB) modulation) by mixing the filtered analog signals I(t) and Q(t), which are output from the filter stage, with quadrature LO signals (e.g., an in-phase LO signal (LO_I) and a quadrature-phase LO signal (LO_Q)) to generate and output an analog RF signal (e.g., a single-sideband modulated RF output signal).

In some embodiments, the quantum bit readout control system 1024 comprises a microwave pulse signal generator that is configured to apply a microwave tone to a given readout resonator line of a given qubit to perform a readout operation to readout the state of the given qubit, as well as circuitry that is configured to process the readout signal generated by the readout resonator line to determine the state of the given qubit, using techniques known to those of ordinary skill in the art.

The quantum computing platform 1010 comprises a software and hardware platform which comprises various software layers that are configured to perform various functions, including, but not limited to, generating and implementing various quantum applications using suitable quantum programming languages, configuring and implementing various quantum gate operations, compiling quantum programs into a quantum assembly language, implementing and utilizing a suitable quantum instruction set architecture (ISA), performing calibration operations to calibrate the quantum circuit elements and gate operations, etc. In addition, the quantum computing platform 1010 comprises a hardware architecture of processors, memory, etc., which is configured to control the execution of quantum applications, and interface with the control system 1030 to (i) generate digital control signals that are converted to analog microwave control signals by the control system 1030, to control operations of the quantum processor 1042 when executing a given quantum application, and (ii) to obtain and process digital signals received from the control system 1030, which represent the processing results generated by the quantum processor 1042 when executing various gate operations for a given quantum application.

In some exemplary embodiments, the quantum computing platform 1010 of the quantum computing system 1000 may be implemented using any suitable computing system architecture which is configured to implement methods to support quantum computing operations by executing computer readable program instructions that are embodied on a computer program product which includes a computer readable storage medium (or media) having such computer readable program instructions thereon for causing a processor to perform control methods as discussed herein.

The quantum computing platform 1010 comprises a software and hardware platform which comprises various software layers that are configured to perform various functions, including, but not limited to, generating and implementing various quantum applications using suitable quantum programming languages, configuring and implementing various quantum gate operations, compiling quantum programs into a quantum assembly language, implementing and utilizing a suitable quantum instruction set architecture (ISA), performing calibration operations to calibrate the quantum circuit elements and gate operations, etc. In addition, the quantum computing platform 1010 comprises a hardware architecture of processors, memory, etc., which is configured to control the execution of quantum applications, and interface with the control system 1030 to (i) generate digital control signals that are converted to analog microwave control signals by the control system 1030, to control operations of the quantum processor 1042 when executing a given quantum application, and (ii) to obtain and process digital signals received from the control system 1030, which represent the processing results generated by the quantum processor 1042 when executing various gate operations for a given quantum application. In some exemplary embodiments, the quantum computing platform 1010 of the quantum computing system 1000 may be implemented using any suitable computing system architecture which is configured to implement methods to support quantum computing operations by executing computer readable program instructions that are embodied on a computer program product which includes a computer readable storage medium (or media) having such computer readable program instructions thereon for causing a processor to perform control methods as discussed herein.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A device, comprising:
a memory operatively coupled to the system, wherein the memory stores computer executable components; and
a processor that executes the computer executable components stored in the memory, wherein the computer executable components comprise:
a self-consistent configuration recovery (SCR) component configured to:
identify a first noisy quantum configuration in a series of quantum configurations associated with a ground state of a system;
process the first noisy quantum configuration to remove an effect of noise on the first noisy quantum configuration, wherein processing of the first noisy quantum configuration generates a first noiseless quantum configuration; and
determine a first ground state of the system, wherein the determination includes generating a first Hamiltonian generated from the series of quantum configurations including the first noiseless quantum configuration.

2. The device of claim 1, wherein the first noisy quantum configuration is generated in a quantum computer configured to represent the system.

3. The device of claim 1, wherein the first noisy quantum configuration includes a first bit string comprising a series of spin orbitals representing respective probabilities of location and spin of an electron in the system, wherein a value 0 in the bit string represents an empty spin orbital and a value of 1 in the bit string represents an occupied spin orbital.

4. The device of claim 3, wherein the SCR component is further configured to diagonalize the first Hamiltonian generated from the noisy quantum configuration to obtain the first ground state.

5. The device of claim 4, wherein the SCR component is further configured to generate the first noiseless quantum configuration by flipping a value of one of the spin orbitals to an opposite value, wherein in the event that a spin orbital value in the first noisy quantum configuration is a zero, flipping the spin orbital value to a value of one.

6. The device of claim 5, wherein the first noisy quantum configuration is included in a set of noisy quantum configurations, the set of noisy quantum configurations further comprises an n^{th} noisy quantum configuration, and the SCR component is further configured to:
remove an effect of noise on the n^{th} noisy configuration to generate an n^{th} noiseless quantum configuration; and
determine the first ground state of the system based on the first Hamiltonian generated from the series of quantum configurations including the first noiseless quantum configuration and the n^{th} noiseless quantum configuration.

7. The device of claim 5, wherein the SCR component is further configured to identify the first noisy quantum configuration based on the occupied spin orbitals in the first bit string, wherein the number of occupied spin orbitals equals a number of electrons identified for the system.

8. The device of claim 1, wherein the SCR component is further configured to:
identify a second noisy configuration in the series of quantum configurations;
process the second noisy quantum configuration to remove an effect of noise on the second noisy quantum configuration, wherein processing of the second noisy quantum configuration generates a second noiseless quantum configuration;
diagonalize a second Hamiltonian to generate a second ground state based on the series of quantum configurations including the second noiseless quantum configuration;
compare the first ground state with the second ground state; and
in response to a determination that a difference between the first ground state and the second ground state satisfies a convergence value, present the second ground state as the ground state of the system.

9. The device of claim 1, wherein the system represents one of an atom or a molecule for which at least one or more location or spin probabilities of an atomic particle is being determined.

10. A computer-implemented method performed by a device operatively coupled to a processor, wherein the method comprising:
receiving, by the device, a set of configurations, wherein the set of configurations are generated in a quantum processor experiencing quantum noise;
diagonalizing, by the device, a first Hamiltonian generated from the set of configurations; and
generating, by the device, a first ground state from the first Hamiltonian.

11. The computer implemented method of claim 10, further comprising:
identifying, by the device, a first number of electrons for a system represented by the set of configurations;
determining, by the device, a first configuration in the set of configurations, wherein the first configuration has a second number of electrons, wherein the second number of electrons is not equal to the first number of electrons; and
modifying, by the device, the first configuration by flipping a value of a first spin-orbital in the spin-orbitals in the first configuration to remove an effect of the quantum noise on the first configuration.

12. The computer-implemented method of claim 11, further comprising:
updating, by the device, the set of configurations with the modified first configuration;
diagonalizing, by the device, a second Hamiltonian generated from the set of configurations; and
generating, by the device, a second ground state from the second Hamiltonian.

13. The computer-implemented method of claim 12, further comprising:
receiving, by the device, a stop criterion;
comparing, by the device, the second ground state with the stop criterion; and
in response to a determination, by the device, that the second ground state complies with the stop criterion, outputting the second ground state as being the ground state of the system represented by the set of configurations.

14. The computer-implemented method of claim 13, wherein the wherein the set of configurations represent probabilistic location of an electron in one of an atom or a molecule.

15. The computer-implemented method of claim 10, further comprising:
identifying, by the device, a first noisy configuration in the set of configurations, wherein a probable position of an atomic particle associated with the first noisy configuration is represented by a bit string of spin orbitals;
modifying, by the device, a first spin orbital in the bit string of spin orbitals from a first value to a second value to convert the first noisy configuration to a first noiseless configuration;
updating, by the device, the set of configurations to include the first noiseless configuration;
diagonalizing, by the device, a second Hamiltonian generated from the updated set of configurations;
generating, by the device, a second ground state from the second Hamiltonian;
comparing, by the device, the first ground state with the second ground state; and
in response to determining, by the device, the first ground state and the second ground state are converging, outputting the second ground state as a ground state of the system.

16. A computer program product stored on a non-transitory computer-readable medium and comprising machine-executable instructions, wherein, in response to being executed, the machine-executable instructions cause a machine to perform operations, comprising:
receiving a set of configurations, wherein the set of configurations are generated in a quantum processor experiencing quantum noise;
diagonalizing a first Hamiltonian generated from the set of configurations; and
generating a first ground state from the first Hamiltonian.

17. The computer program product according to claim 16, wherein the operations further comprise:
identifying a first number of electrons for a system represented by the set of configurations;
determining a first configuration in the set of configurations, wherein the first configuration has a second number of electrons, wherein the second number of electrons is not equal to the first number of electrons; and
modifying the first configuration by flipping a value of a first spin-orbital in the spin-orbitals in the first configuration to remove an effect of the quantum noise on the first configuration.

18. The computer program product according to claim 17, wherein the operations further comprise:
updating the set of configurations with the modified first configuration;
diagonalizing a second Hamiltonian generated from the updated set of configurations;
generating a second ground state from the second Hamiltonian.

19. The computer program product according to claim 17, wherein the system is an atom or a molecule, and the set of configurations represent probabilistic location of an atomic particle in the system.

20. The computer program product according to claim 17, wherein the atomic particle is a boson or a fermion.
